(19) United States
(12) Patent Application Publication
(10) Pub. No.: US 2013/0335036 A1
(43) Pub. Date: Dec. 19, 2013

(54) BALANCE CHARGING DETECTOR

(71) Applicants: Tao ZHANG, Shanghai (CN); Jiangiang RUI, Shanghai (CN); Falong LI, Shanghai (CN); Zhihao HU, Wuhan (CN)

(72) Inventors: Tao ZHANG, Shanghai (CN); Jiangiang RUI, Shanghai (CN); Falong LI, Shanghai (CN); Zhihao HU, Wuhan (CN)

(21) Appl. No.: 13/537,820

(22) Filed: Jun. 29, 2012

(30) Foreign Application Priority Data
Jun. 15, 2012 (CN) 201210198838.7

(51) Int. Cl. H02J 7/00

(52) U.S. Cl. 320/162

(57) ABSTRACT

A balance charging detector is configured to detect a balance charging condition for a battery. The balance charging detector includes a controller and a comparing module. The controller is configured to monitor a status of the battery, access battery parameters for the battery that correspond to the status, and generate a group of balance charging parameters based on the battery parameters. The comparing module is configured to set a balance charging flag based on a comparison of the group of balance charging parameters and a set of thresholds. A balance charging signal can be generated if the balance charging flag is set to indicate presence of a condition to perform a balance charging of the battery.

### RELATED APPLICATION

This application claims priority to Chinese Patent Application No. 201210198838.7, filed on Jun. 15, 2012, with the State Intellectual Property Office of the People's Republic of China.

### BACKGROUND

A battery, e.g., a Li-ion battery, can include multiple modules, and each module can include multiple cells connected in parallel and/or in series. In a multi-module/cell battery, the amount of imbalance between the modules/cells may increase as the number of charging/discharging cycles increases, which may reduce the available capacity of the battery and shorten the battery life. Balance charging the battery can reduce the imbalance and therefore lengthen the battery's service life.

FIG. 1 shows a diagram of a conventional battery system 100. The battery system 100 includes a battery pack 102 and a balancing charger 104 connected to a power supply 106 to charge the battery pack 102. The battery pack 102 includes a battery 112 that includes multiple modules/cells, and a battery management system (BMS) 114. The battery management system 114 monitors a condition of the battery 112 and communicates with the balancing charger 104 to control a charging/discharging process according to the condition of the battery 112. The balancing charger 104 can perform a regular charging round or a balance charging round. Usually, the selection between the regular charging round and the balance charging round is implemented manually.

However, balance charging can lead to problems such as gassing, water loss, and internal heat. Therefore, determining the proper condition for performing balance charging is important so that balance charging is not performed too frequently or is not performed unnecessarily.

### SUMMARY

In one embodiment, a balance charging detector is configured to detect a balance charging condition for a battery. The balance charging detector includes a controller and a comparing module. The controller is configured to monitor a status of the battery, access battery parameters for the battery that correspond to the status, and generate a group of balance charging parameters based on the battery parameters. The comparing module is configured to set a balance charging flag based on a comparison of the group of balance charging parameters and a set of thresholds. A balance charging signal can be generated if the balance charging flag is set to indicate presence of a condition to perform a balance charging of the battery.

### BRIEF DESCRIPTION OF THE DRAWINGS

Features and advantages of embodiments of the claimed subject matter will become apparent as the following detailed description proceeds, and upon reference to the drawings, wherein like numerals depict like parts, and in which:

FIG. 1 shows a diagram of a conventional battery system.

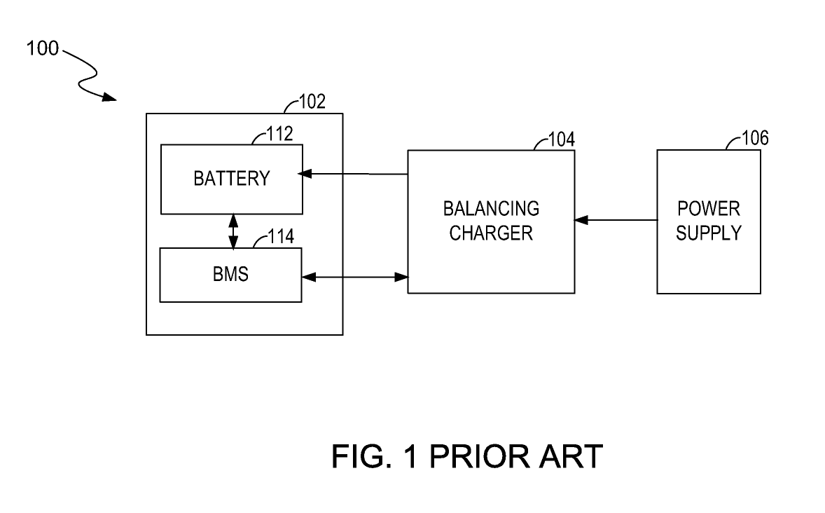

FIG. 2 shows a diagram of a battery system, in accordance with one embodiment of the present invention.

FIG. 3 shows a diagram of a battery management system, in accordance with one embodiment of the present invention.

FIG. 4 shows a diagram of a balance charging detector, in accordance with one embodiment of the present invention.

FIG. 5 shows a flowchart of a flag setting process that can be implemented using the comparison unit 410 of FIG. 4, in accordance with one embodiment of the present invention.

FIG. 6 shows a flowchart of a flag setting process that can be implemented using the comparison unit 420 of FIG. 4, in accordance with one embodiment of the present invention.

FIG. 7 shows a flowchart of a flag setting process that can be implemented using the comparison unit 430 of FIG. 4, in accordance with one embodiment of the present invention.

FIG. 8 shows a flowchart of a flag setting process that can be implemented using the comparison unit 440 of FIG. 4, in accordance with one embodiment of the present invention.

FIG. 9 shows a flowchart of a flag setting process that can be implemented using the comparison unit 450 of FIG. 4, in accordance with one embodiment of the present invention.

FIG. 10 shows a flowchart of a flag setting process that can be implemented using the comparison unit 460 of FIG. 4, in accordance with another embodiment of the present invention.

FIG. 11 shows a flowchart of a method for detecting a balance charging condition, in accordance with one embodiment of the present invention.

### DETAILED DESCRIPTION

Reference will now be made in detail to the embodiments of the present invention. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

According to one embodiment of the present invention, a balance charging detector is configured to detect a condition to balance charge a battery. Advantageously, the balance charging detector is capable of setting balance charging flags that indicate a balance charging condition is present, and is also capable of generating a balance charging signal according to the balance charging flags. Consequently, a balance charging condition does not need to be determined manually, and unnecessary balance charging rounds will be avoided. The battery life can be extended accordingly. Moreover, different types of balance charging conditions can be represented by respective balance charging flags.

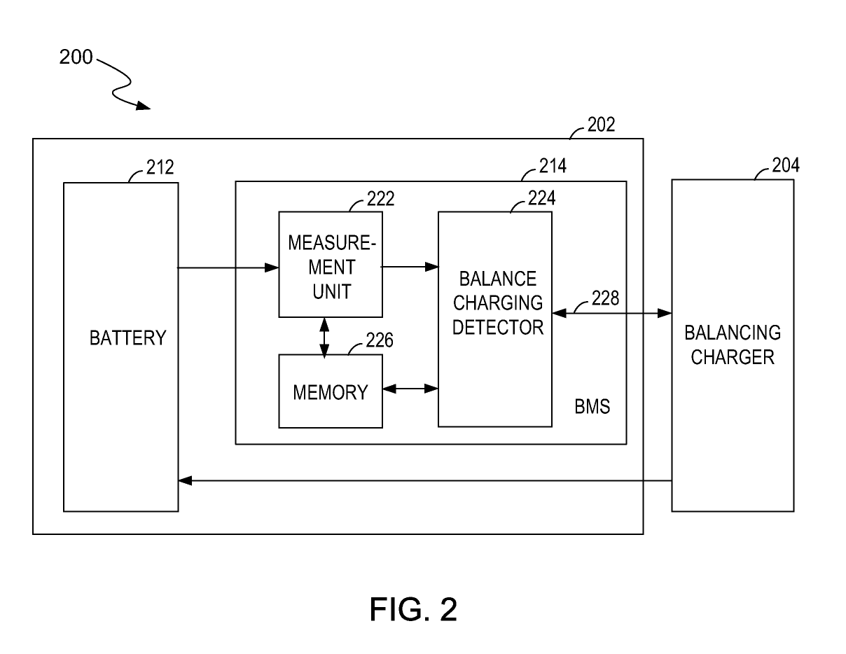

FIG. 2 shows a diagram of a battery system 200, in accordance with one embodiment of the present invention. The battery system 200 includes a battery pack 202 and a balancing charger 204 for charging the battery pack 202. The battery pack 202 includes a battery 212 that includes multiple modules and a battery management system (BMS) 214. Each module includes one or more cells. The battery management system 214 includes a measurement unit 222, a memory 226, and a balance charging detector 224. The measurement unit 222 is configured to detect a status (e.g., module/cell voltage, module/cell temperature, battery voltage, battery current, etc.) including a charging/discharging status (charging duration, charging temperature, etc.) of the battery 212. The status including the charging/discharging status can be represented by a plurality of battery status parameters.

The memory 226 is configured to store values for the battery status parameters and BMS information such as BMS on/off time (idle time) and a count of the number of charging rounds (which represents the number of times a charging round has been executed). The balance charging detector 224 can receive or access a set of battery status parameter values and the BMS information from the measurement unit 222 and/or the memory 226. The balance charging detector 224 can determine whether to perform a balance charging for the battery 212 according to the values of the battery status parameters and the BMS information, and output a balance charging signal 228 to instruct the balance charger 204 to perform the balance charging. The balancing charger 204 can implement a regular charging round or a balance charging round according to the signals output from the battery management system 214. In one embodiment, the balance charger 204 includes a balancer (not shown in the figures) that monitors individual module/cell voltages in a battery pack and adjusts the charging rate of the modules/cells accordingly. When the balance charger 204 receives the balance charging signal 228 from the balance charging detector 224, the balance charger 204 initiates a balance charging round for the battery 212.

Thus, the battery management system 214, including the integrated balance charging detector 224, can monitor the battery status of the battery 212 and output a balance charging signal 228 to instruct the balance charger 204 to perform the balance charging. Advantageously, the balance charging condition does not need to be determined manually, and therefore unnecessary balance charging rounds will not be performed. Consequently, the battery life can be extended.

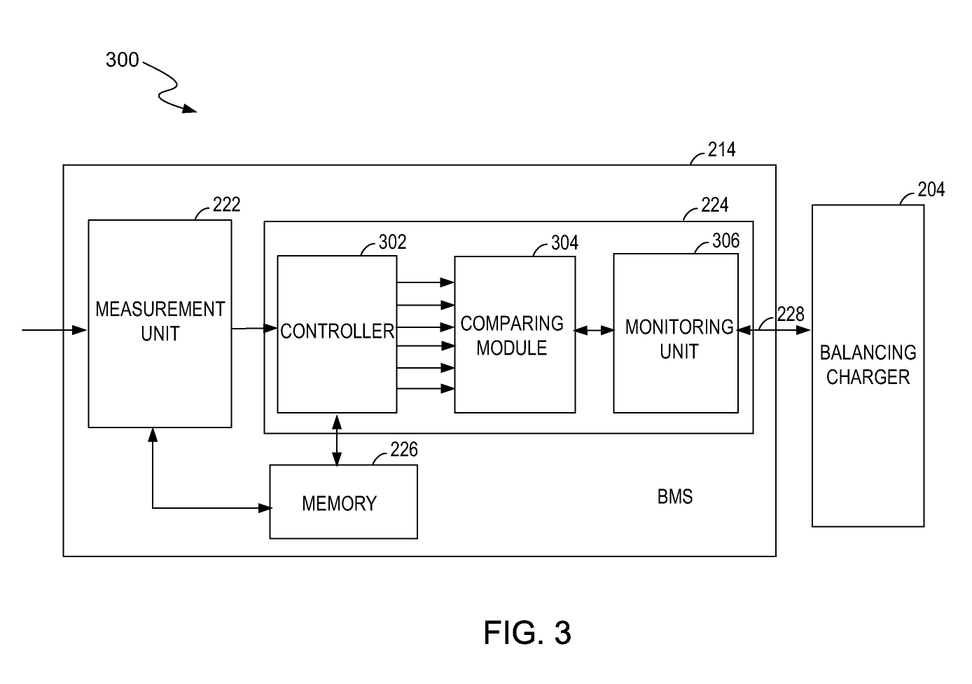

FIG. 3 shows a diagram of a battery management system 300, in accordance with one embodiment of the present invention. FIG. 3 is described in combination with FIG. 2. Elements that are labeled the same as in FIG. 2 have similar functions. The battery management system 300 includes the measurement unit 222, the memory 226 and the balance charging detector 224. The balance charging detector 224 includes a controller 302, a comparing module 304 and a monitoring unit 306.

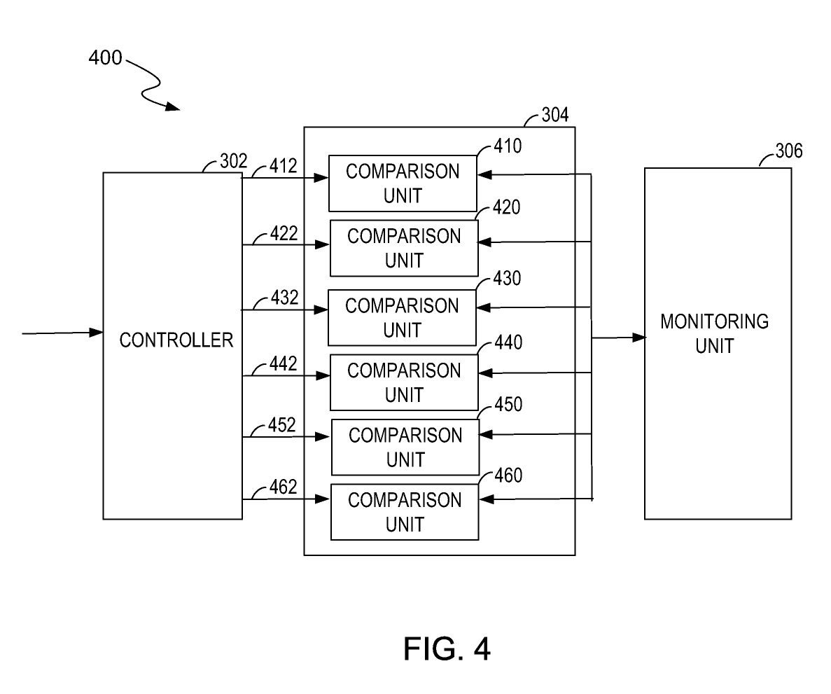

The controller 302 is configured to determine whether the battery 212 is at a detecting moment and, if so, can access the values for the battery parameters (battery status parameters and BMS information) from the memory 226 and/or from the measurement unit 222, and can then generate values for one or more groups of balance charging parameters based on the values for the battery parameters. A detecting moment of the battery 212 can occur at points such as but not limited to: after every regular charging round, before every discharging round, and each time the BMS 214 turns on. The types of balance charging parameters generated by the controller 302 are discussed further in conjunction with FIGS. 4 through 10 below.

The comparing module 304 receives values for the balance charging parameters from the controller 302 and sets one or more balance charging flags based on the result of a comparison between the battery charging parameters and a corresponding threshold or set of thresholds. There may be multiple balance charging flags, for example, one flag per group of balance charging parameters.

The monitoring unit 306 outputs the balance charging signal 228 if a balance charging flag is set when the balance charger 204 is connected to the battery 212. In other words, when the monitoring unit 306 detects a connection between the charger 204 and the battery 212, the monitoring unit 306 checks whether a balance charging flag is set. If a balance charging flag is set, the balance charging signal 228 is output to the balance charger 204 to indicate the presence of a balance charging condition. In one embodiment, if multiple balance charging flags are set, then any one of the balance charging flags can trigger the balance charging signal 228.

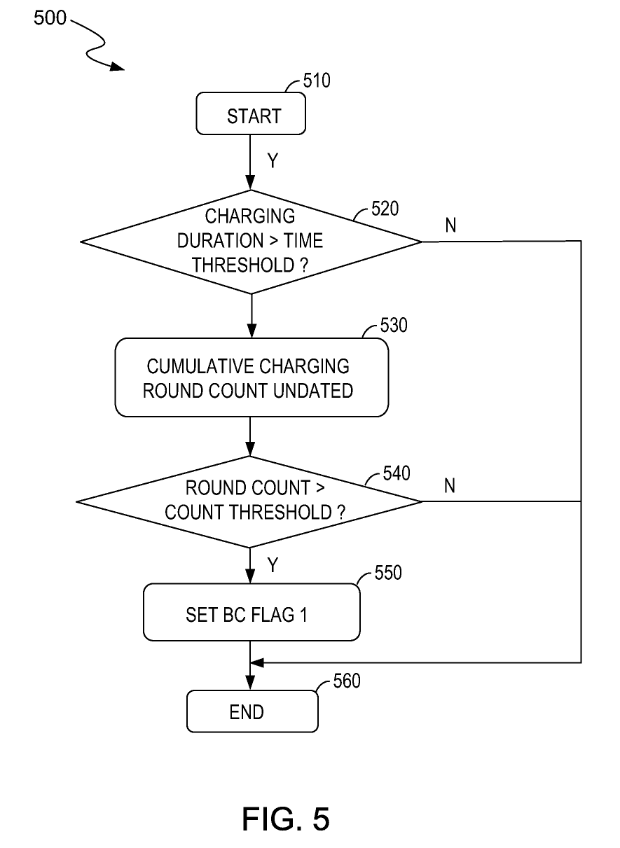

FIG. 4 shows a diagram of a balance charging detector 400, such as the balance charging detector 224 from FIG. 2, in accordance with one embodiment of the present invention. FIG. 4 is described in combination with FIG. 2 and FIG. 3. Elements that are labeled the same as in FIG. 2 and FIG. 3 have similar functions. The balance charging detector 400 includes the controller 302, the comparing module 304, and the monitoring unit 306. In one embodiment, the comparing module 304 includes six (6) comparison units 410, 420, 430, 440, 450 and 460. In such an embodiment, there are 6 groups of balance charging parameters 412, 422, 432, 442, 452, and 462, one group per comparison unit. Each comparison unit compares values for a respective group of balance charging parameters with a respective set of thresholds, and sets a corresponding balance charging flag based on the comparison result. The groups of balance charging parameters 412, 422, 432, 442, 452, and 462 and the sets of thresholds will be described in combination with FIGS. 5, 6, 7, 8, 9, and 10. Although 6 comparison units 410, 420, 430, 440, 450, and 460 are illustrated in FIG. 4, the present invention is not so limited and any number of comparison units may be used with a corresponding number of balance charging parameters and balance charging flags.

FIG. 5 shows a flowchart of a flag setting process 500 that can be implemented using the comparison unit 410 of FIG. 4, in accordance with one embodiment of the present invention. Generally speaking, the comparison unit 410 sets a balance charging flag 1 based on the number of charging rounds. Although specific steps are disclosed in FIG. 5, such steps are just examples. That is, the present invention is well suited to performing various other steps or variations of the steps recited in FIG. 5. FIG. 5 is described in combination with FIG. 3 and FIG. 4.

As presented above, the controller 302 determines whether the battery 212 is at a detecting moment. If so, the controller 302 accesses the battery parameters from the measurement unit 222 and/or the memory 226 that are associated with the current detecting moment, and generates a group of balance charging parameters 412 based on those battery parameters. In the FIG. 5 embodiment, a detecting moment occurs after every regular charging round, and the battery parameters used for generating the group of balance charging parameters 412 include a charging duration and a battery temperature for the preceding charging round, and a cumulative count of the number of charging rounds, which can be accessed or received from the memory 226. In this example, the group of balance charging parameters 412 is the same as the battery parameters, in which case the controller 302 need not perform calculations such as those mentioned above. The comparison unit 410 compares the group of balance charging parameters 412 with a set of thresholds that includes a time threshold, a temperature range, and a count threshold, and sets a balance charging flag 1 depending on the results of the comparisons, as described more fully in conjunction with FIG. 5.

Referring to FIG. 5, in block 510, the comparison unit 410 accesses the group of balance charging parameters 412, which includes the charging duration for the previous charging round (the amount of time needed to complete the previous charging round), the battery temperature for the previous charging round, and the current value of the cumulative charging round count.

In block 520, the comparison unit 410 compares the charging duration for the previous charging round with the time threshold.

If the charging duration is shorter than the time threshold, then the flag setting process is ended, in block 560. When the charging duration for a charging round is shorter than the predetermined time threshold, the charging round is not included in the cumulative charging round count.

If the charging duration is longer than the time threshold, then the comparison unit 410 updates the cumulative charging round count depending on the battery temperature for the previous charging round, in block 530. Generally, the temperature of a battery during charging is higher than usual, and the battery temperature can impact a battery's service life. The comparison unit 410 does not update the cumulative charging round count simply according to an actual charging round count but depending on a weighted charging round count associated with the battery temperature for the previous charging round, in one embodiment. For example, if the battery temperature for the previous charging round is lower than the temperature range, then the cumulative charging round count is incremented by two (2) counts; in other words, the updated cumulative charging round count is equal to its previous value plus 2. If the battery temperature for the previous charging round is within the temperature range, then the cumulative charging round count is incremented by one (1) count. If the battery temperature for the previous charging round is greater than the temperature range, then the cumulative charging round count is not changed.

In block 540, the comparison unit 410 compares the updated cumulative charging round count with the count threshold.

If the updated cumulative charging round count is less than the count threshold, the flag setting process is ended, in block 560.

If the updated cumulative charging round count is greater than or equal to the count threshold, the comparison unit 410 sets the balance charging (BC) flag 1, in block 550.

In block 560, the flag setting process 500 of the comparison unit 410 is ended, and can be repeated the next time a detecting moment occurs.

Advantageously, because the comparison unit 410 sets the balance charging flag 1 based on the updated cumulative charging round count, balance charging can be implemented automatically instead of manually. Moreover, because the updated cumulative charging round count is not simply equal to the actual number of charging rounds (e.g., under some circumstances, the cumulative count is not changed), balance charging may be performed less frequently or only when it is particularly needed, reducing or even eliminating unnecessary balance charging rounds.

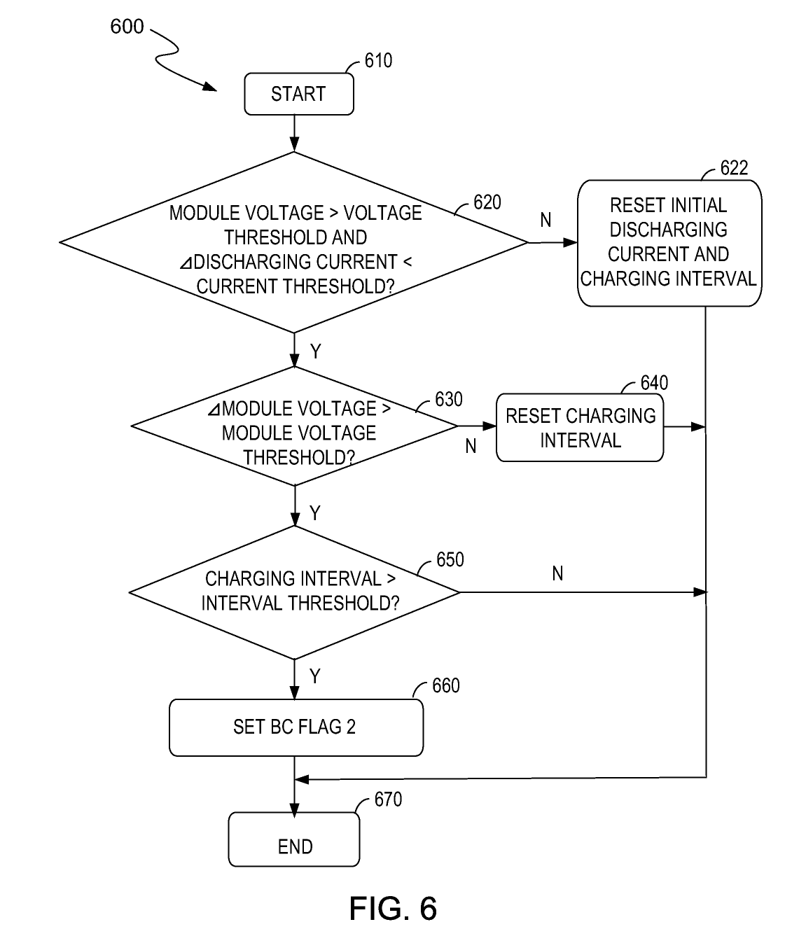

FIG. 6 shows a flowchart of a flag setting process 600 that can be implemented using the comparison unit 420 of FIG. 4, in accordance with one embodiment of the present invention. Generally speaking, the comparison unit 420 sets a balance charging flag 2 depending on the difference in module voltages for two modules of the battery 212. Although specific steps are disclosed in FIG. 6, such steps are just examples. That is, the present invention is well suited to performing various other steps or variations of the steps recited in FIG. 6. FIG. 6 is described in combination with FIG. 3 and FIG. 4.

As presented above, the controller 302 determines whether the battery 212 is at a detecting moment. If so, the controller 302 accesses battery parameters from the measurement unit 222 and/or the memory 226 associated with the current detecting moment, and generates a group of balance charging parameters 422 based on those battery parameters. In the FIG. 6 embodiment, a detecting moment occurs before every discharging round. The battery parameters used for generating the group of balance charging parameters 422 include module voltages, an initial battery current, and a discharging current, which can be accessed or received from the measurement unit 222. In this example, the group of balance charging parameters 422 includes a module voltage difference, a discharging current difference, and an average module voltage. The module voltage difference and the average module voltage can be calculated by the controller 302 using the individual module voltages. The module voltage difference is the difference in voltage between the module with the highest voltage and the module with the lowest voltage; however, in general, the module voltage difference can be the voltage difference between any two modules. The average module voltage is the average voltage across the modules or across some subset of the modules. The discharging current difference can be calculated by the controller 302 using the initial battery current and the discharging current. The comparison unit 420 compares the group of balance charging parameters 422 with a set of thresholds that includes a voltage threshold, a current threshold, a module voltage threshold, and a charging interval threshold. The comparison unit 420 sets a balance charging flag 2 if a conditional module voltage difference is greater than the module voltage threshold. The module voltage difference qualifies as the conditional module voltage difference if certain requirements related to the discharging current and the average module voltage are satisfied, as described more fully in conjunction with FIG. 6.

Referring to FIG. 6, in block 610, the comparison unit 420 accesses the group of balance charging parameters 422, which includes the module voltage difference, the discharging current difference, and the average module voltage.

In block 620, the comparison unit 420 compares the average module voltage with the voltage threshold, and compares the discharging current difference with the current threshold. Because the discharging current difference can influence the module voltage, the comparison unit 420 does not set the balance charging flag 2 at this point.

If the average module voltage is less than the voltage threshold or if the discharging current difference is greater than the current threshold, then the initial discharging current and charging interval are reset, in block 622, and then the flag setting process 600 is ended, in block 670. Otherwise, the flag setting process proceeds to block 630.

If the average module voltage is greater than the voltage threshold and the discharging current difference is less than the current threshold, then the comparison unit 420 compares the module voltage difference with a module voltage threshold, in block 630.

If the module voltage difference is less than the module voltage threshold, then the charging interval is reset, in block 640, and then the flag setting process 600 is ended, in block 670.

If the module voltage difference is greater than the module voltage threshold, then the comparison unit 420 compares the charging interval with the charging interval threshold, in block 650.

If the charging interval is less than the charging interval threshold, then the flag setting process 600 is ended, in block 670.

If the charging interval is greater than the charging interval threshold, then the comparison unit 420 sets the balance charging flag 2, in block 660.

In block 670, the flag setting process 600 of the comparison unit 420 is ended, and can be repeated the next time a detecting moment occurs.

The module voltage threshold and the charging interval can be changed. For example, if the module voltage difference is greater than module voltage threshold for some number of consecutive balance charging rounds because the battery is aging severely, then the module voltage threshold and the charging interval can be increased.

Advantageously, because the comparison unit 420 sets the balance charging flag 2 based on the conditional module voltage difference, balance charging can be implemented automatically instead of manually. Moreover, because the balancing charging flag 2 is set only if certain conditions are satisfied, the number of balance charging rounds can be reduced and unnecessary balance charging rounds can be eliminated.

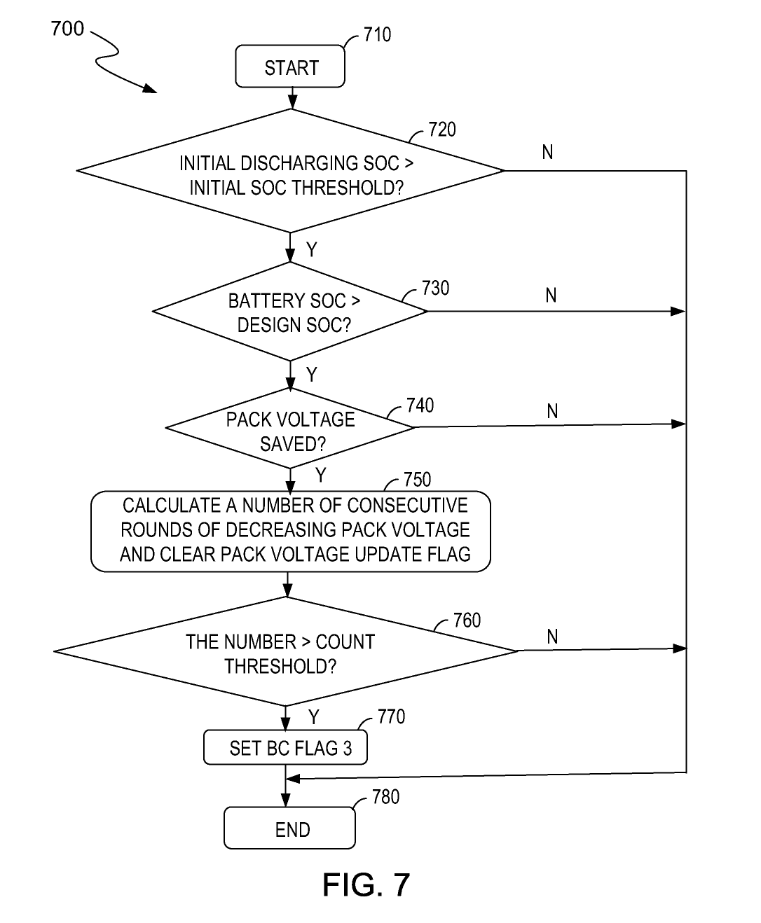

FIG. 7 shows a flowchart of a flag setting process 700 that can be implemented using the comparison unit 430 of FIG. 4, in accordance with one embodiment of the present invention. Generally speaking, the comparison unit 430 sets a balance charging flag 3 depending on the number of consecutive rounds of decreasing battery pack voltages. Although specific steps are disclosed in FIG. 7, such steps are just examples. That is, the present invention is well suited to performing various other steps or variations of the steps recited in FIG. 7. FIG. 7 is described in combination with FIG. 3 and FIG. 4.

As presented above, the controller 302 determines whether the battery 212 is at a detecting moment. If so, the controller 302 accesses battery parameters from the measurement unit 222 and/or the memory 226 associated with the current detecting moment, and generates a group of balance charging parameters 432 based on those battery parameters. In the FIG. 7 embodiment, a detecting moment occurs before every discharging round, and the battery parameters used for generating the group of balance charging parameters 432 includes the initial discharging SOC, battery SOC, and battery pack voltages measured in the current and preceding round or rounds. The initial discharging SOC, the battery SOC and the battery pack voltage of the current round are received or accessed from the measurement unit 222, and the battery pack voltages of previous rounds are accessed from the memory 226. The battery parameters can be used by the controller 302 to calculate balance charging parameters 432 including the number of consecutive rounds of decreasing pack voltages.

In one embodiment, during every discharging round, at the time the BMS 214 determines that the battery 212 has a certain state of charge (SOC), e.g., 70%, the measurement unit 222 accesses a battery pack voltage of the battery 212 and stores the battery pack voltage for the current round in the memory 226. A battery pack voltage update flag can be used to indicate that the battery pack voltage for the current round has been measured. Therefore, the battery pack voltages measured from the current and preceding round or rounds can be stored in the memory 226. The controller 302 then checks the battery pack voltage update flag and calculates the number of consecutive rounds of decreasing pack voltages based on the battery pack voltages if the update flag is set. The comparison unit 430 compares the balance charging parameters 432 with a set of thresholds that includes an initial SOC threshold, a design SOC threshold, and a count threshold. The comparison unit 430 sets a balance charging flag 3 if the number of consecutive rounds of decreasing pack voltages is greater than the count threshold, as described more fully in conjunction with FIG. 7.

Referring to FIG. 7, in block 710, the comparison unit 430 accesses the group of balance charging parameters 432, which includes the initial discharging SOC, the battery capacity, and the current number of consecutive rounds of decreasing pack voltages.

In block 720, the comparison unit 430 compares the initial discharging SOC with the initial SOC threshold, e.g., 98%. The initial discharging SOC is the battery SOC at the beginning of the discharging round.

If the initial discharging SOC is less than the initial SOC threshold, then the flag setting process 700 is ended, in block 780.

If the initial discharging SOC is greater than the initial SOC threshold, then the comparison unit 430 compares the current battery SOC with the design SOC threshold, e.g., 70%, in block 730.

If the battery SOC is greater than the design SOC threshold, then the flag setting process 700 is ended, in block 780.

If the battery SOC is less than the design SOC threshold, then the controller 302 checks whether the battery pack voltage for the current round has been measured and stored in the memory 226 based on the state of the battery pack voltage update flag, in block 740.

If the battery pack voltage has not been measured and saved, then the flag setting process 700 is ended, in block 780.

If the battery pack voltage has been measured and saved, then the number of consecutive rounds of decreasing pack voltages is calculated and the battery pack voltage update flag is cleared, in block 750. Then, the comparison unit 430 compares the number of consecutive rounds of decreasing pack voltages with the count threshold, in block 760.

If the number of consecutive rounds of decreasing pack voltages is less than the count threshold, then the flag setting process 700 is ended, in block 780.

If the number of consecutive rounds of decreasing pack voltages is greater than or equal to the count threshold, then the comparison unit 430 sets the balance charging flag 3, in block 770.

In block 780, the flag setting process 700 of the comparison unit 430 is ended, and can be repeated the next time a detecting moment occurs.

Advantageously, because the comparison unit 430 sets the balance charging flag 3 based on the number of consecutive rounds of decreasing pack voltages, the influence of transient voltage fluctuations is reduced. Specifically, the battery pack voltage of one discharging round can decrease compared to the previous round simply because of voltage fluctuations, for example. If a balance charging is performed only as a result of such a decrease, unnecessary balance charging will be implemented. Because, in the present embodiment, the balance charging is performed when the number of consecutive rounds of decreasing pack voltages reaches a threshold, the effect of voltage fluctuations can be reduced. Therefore, unnecessary balance charging can be avoided.

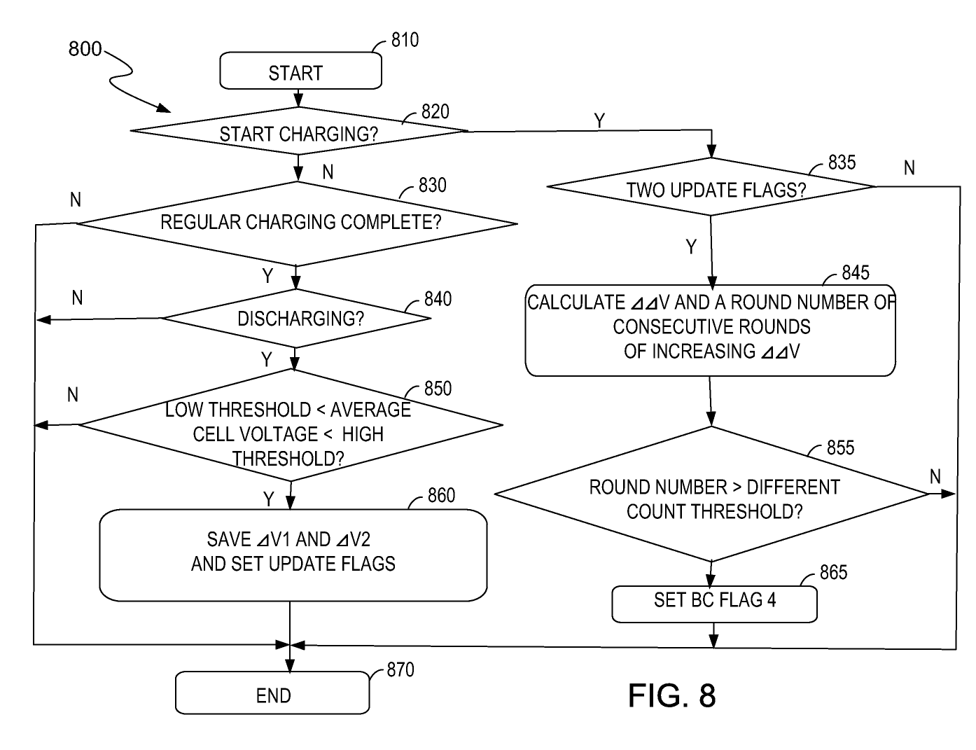

FIG. 8 shows a flowchart of a flag setting process 800 that can be implemented using the comparison unit 440 of FIG. 4, in accordance with one embodiment of the present invention. Generally speaking, the comparison unit 440 sets a balance charging flag 4 if the difference between module voltages increases over a count threshold. For example, in a first discharging round, when an average cell voltage of battery 212 is in a specified voltage range, e.g., 2.0V-2.1V, the module voltage differences between two modules can be calculated by the controller 312. The module voltage differences can be calculated for each pair of adjacent modules, for example. The highest module voltage difference ΔV1 and the lowest module voltage difference ΔV2 are then identified. A module voltage difference ΔΔV between ΔV1 and ΔV2 can be calculated by the controller 302 and stored in the memory 226. Similarly, in a second discharging round, when the average cell voltage of battery 212 is in the same voltage range (e.g., 2.0V-2.1V), the module voltage difference ΔΔV can be calculated again as described above. The module voltage difference ΔΔV may increase from one balancing round to the next; if so, and if the number of consecutive rounds in which ΔΔV increases reaches a threshold value, e.g., five (5), then the balance charging flag 4 can be set to trigger balance charging. Although specific steps are disclosed in FIG. 8, such steps are just examples. That is, the present invention is well suited to performing various other steps or variations of the steps recited in FIG. 8. FIG. 8 is described in combination with FIG. 3 and FIG. 4.

As presented above, the controller 302 determines whether the battery 212 is at a detecting moment. If so, the controller 302 accesses battery parameters from the measurement unit 222 and/or the memory 226 associated with the current detecting moment, and generates a group of balance charging parameters 442 based on those battery parameters. In the FIG. 8 embodiment, a detecting moment occurs before every charging round, and the battery parameters used to generate the group of balance charging parameters 442 include cell voltages and module voltages from the current discharging round, which are received or accessed from the measurement unit 222, and cell voltages and module voltages from the preceding discharging rounds, which are accessed from the memory 226. The group of balance charging parameters 442 includes the average cell voltage, the module voltage differences between ΔV1 and ΔV2 (ΔΔV) (the differences between the highest and lowest module voltage differences for each discharging round of interest), and the number of consecutive rounds in which ΔΔV increases, which can be calculated by the controller 302 using the above mentioned battery parameters. The comparison unit 440 compares the group of balance charging parameters 442 with a set of thresholds that includes a low threshold, a high threshold, and a count threshold. The comparison unit 440 sets a balance charging flag 4 if the number of consecutive rounds in which the difference between the highest and lowest module voltage differences (ΔΔV) increases is greater than the count threshold.

Referring back to FIG. 8, in block 810, the comparison unit 430 accesses the group of balance charging parameters 442, which includes cell voltages and module voltages from current and preceding discharging rounds.

In block 820, the controller 302 determines whether a charging round is started.

In block 830, the controller 302 determines whether the previous round of regular charging is completed.

If the previous round of regular charging is not completed, then the flag setting process 800 is ended, in block 870.

If the previous round of regular charging is completed, then the controller 302 determines whether the battery 212 is in a discharging round, in block 840.

If the battery 212 is not in a discharging round, then the flag setting process 800 is ended, in block 870.

If the battery 212 is in a discharging round, then the comparison unit 440 compares the average cell voltage with a low threshold and a high threshold, in block 850. In other words, the comparison unit 440 detects whether the average cell voltage is in the voltage range between the low threshold and the high threshold.

If the average cell voltage is not in the voltage range between the low and the high thresholds, then the flag setting process 800 is ended, in block 870.

If the average cell voltage is in the voltage range, then the controller 302 calculates the highest module voltage difference ΔV1 and the lowest module voltage difference ΔV2, saves ΔV1 and ΔV2 in the memory 226, and sets two update flags, in block 860. In one embodiment, the two update flags indicate, respectively, that the highest module voltage difference ΔV1 and the lowest module voltage difference ΔV2 for the current discharging round are saved in the memory 226.

Referring back to block 820, if the controller 302 determines the charging round is started, then the controller 302 checks whether there are two update flags set, in block 835.

If two update flags are not set, then the flag setting process 800 is ended, in block 870.

If two update flags are set, then the controller 302 calculates the module voltage differences ΔΔV (=ΔV1−ΔV2) for the previous discharging round, saves ΔΔV in memory 226, and clears the update flags, and the controller 302 further calculates the number of consecutive rounds in which ΔΔV increases, in block 845.

The comparison unit 340 then compares the number of consecutive rounds in which ΔΔV increases with the count threshold, in block 855.

If the number of consecutive rounds in which ΔΔV increases is less than the count threshold, then the flag setting process 800 is ended, in block 870.

If the number of consecutive rounds in which ΔΔV increases is greater than or equal to the count threshold, then the comparison unit 440 sets the balance charging flag 4, in block 865.

In block 870, the flag setting process 800 is ended, and can be repeated the next time a detecting moment occurs.

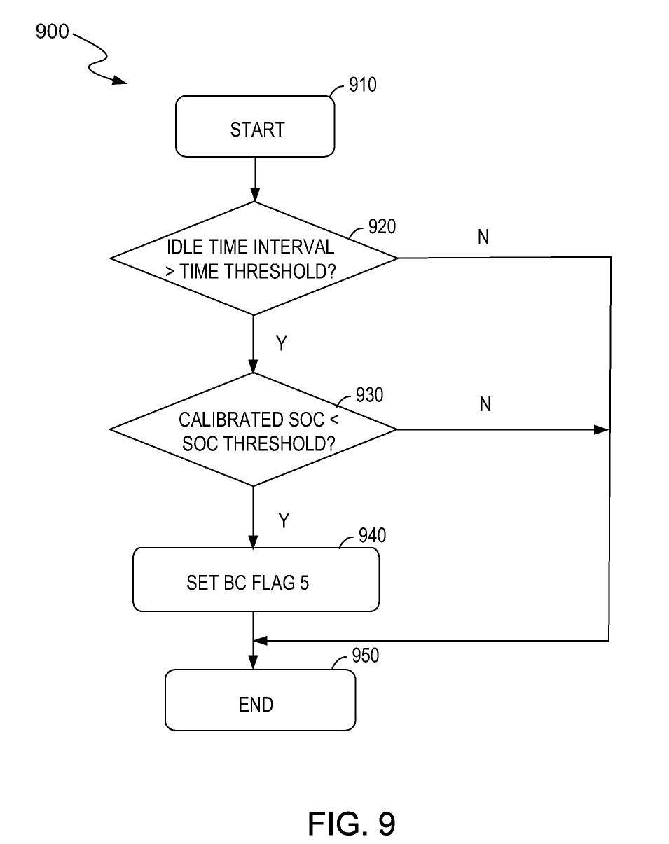

FIG. 9 shows a flowchart of a flag setting process 900 that can be implemented using the comparison unit 450 in FIG. 4, in accordance with one embodiment of the present invention. FIG. 9 is described in combination with FIG. 3 and FIG. 4. In general, the comparison unit 450 sets a balance charging flag 5 if a conditional idle time interval of the battery 212 reaches a threshold. When the conditional idle time of battery 212 is longer than a time threshold, a balance charging can be performed. Although specific steps are disclosed in FIG. 9, such steps are just examples. That is, the present invention is well suited to performing various other steps or variations of the steps recited in FIG. 9. FIG. 9 is described in combination with FIG. 3 and FIG. 4.

As presented above, the controller 302 determines whether the battery 212 is at a detecting moment. If so, the controller 302 accesses battery parameters from the measurement unit 222 and/or the memory 226 associated with the current detecting moment, and generates a group of balance charging parameters 452 based on those battery parameters. In the FIG. 9 embodiment, a detecting moment occurs each time the BMS 214 turns on. The battery parameters used for generating the group of balance charging parameters 452 include a previous BMS turning off time, a BMS turning on time, and a calibrated SOC. The BMS turning off and turning on times are received from the memory 226, and the calibrated SOC is received from the measurement unit 222. In one embodiment, the calibrated SOC is an open circuit SOC when the BMS 214 turns on, and the idle time interval is the time interval between the BMS turning off time and the BMS turning on time. The group of balance charging parameters 452 includes an idle time interval that can be calculated by the controller 302 using the above mentioned battery parameters and the calibrated SOC. The comparison unit 450 compares the group of balance charging parameters 452 with a set of thresholds that includes a time threshold and a SOC threshold. The comparison unit 450 sets a balance charging flag 5 if a conditional idle time interval is greater than the time threshold. The idle time interval can be qualified as the conditional idle time interval based on the calibrated SOC and the SOC threshold.

Referring to FIG. 9, in block 910, the comparison unit 450 accesses/receives the group of balance charging parameters 452, which includes the idle time interval and the calibrated SOC.

In block 920, the comparison unit 450 compares the idle time interval with the time threshold.

If the idle time interval is less than the time threshold, then the flag setting process 900 is ended, in block 950.

If the idle time interval is greater than the time threshold, then the comparison unit 450 compares the calibrated SOC with the SOC threshold, in block 930. In certain circumstances, such as when the BMS is installed or the BMS battery is changed, the idle time interval calculated by the controller 302 may be greater than the time threshold but a balance charging is actually unnecessary, and therefore the calibrated SOC is employed to further determine whether the idle time interval qualifies as the conditional idle time interval.

If the calibrated SOC is greater than the SOC threshold, then the flag setting process 900 is ended, in block 950.

If the calibrated SOC is less than the SOC threshold, then the comparison unit 450 sets the balance charging flag 5, in block 940.

In block 950, the flag setting process 900 of the comparison unit 450 is ended, and can be repeated the next time a detecting moment occurs.

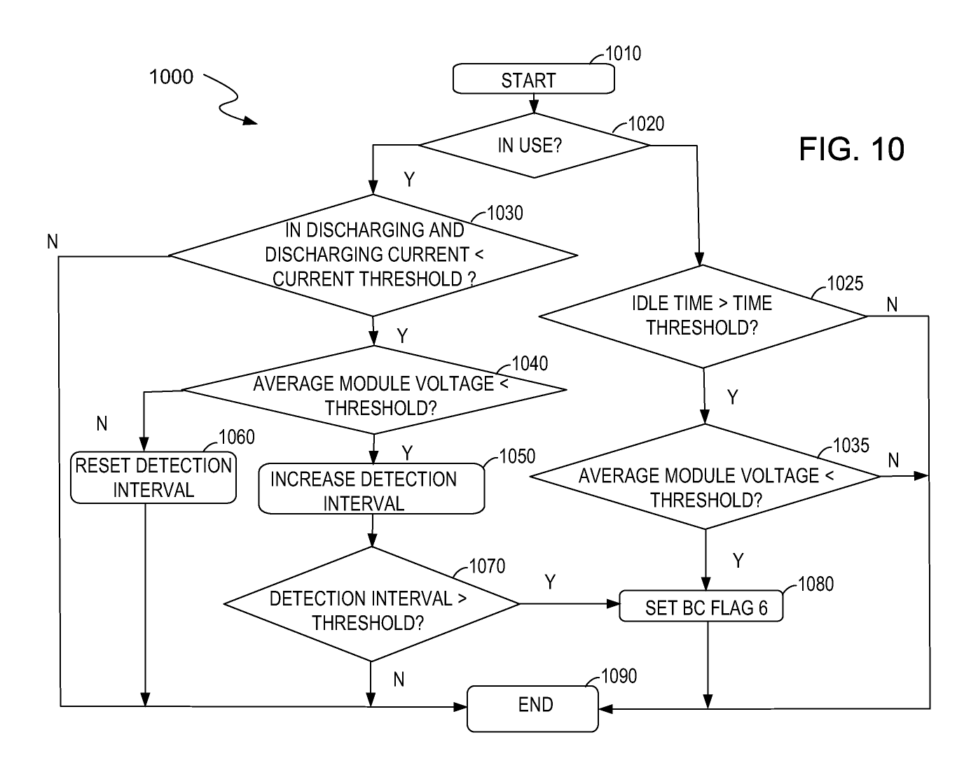

FIG. 10 shows a flowchart of a flag setting process 1000 that can be implemented using the comparison unit 460 of FIG. 4, in accordance with one embodiment of the present invention. In general, the comparison unit 460 sets a balance charging flag 6 if the battery 212 is in an over-discharged condition, in which the average module voltage is less than a threshold. In the over-discharged condition, if the battery 212 is not in use (in an idle state), then the average module voltage will be less than an idle voltage threshold, and if the battery 212 is in a discharging state and the discharging current is less than a certain value, then the average module voltage will be less than a discharging voltage threshold. Although specific steps are disclosed in FIG. 10, such steps are just examples. That is, the present invention is well suited to performing various other steps or variations of the steps recited in FIG. 10. FIG. 10 is described in combination with FIG. 3 and FIG. 4.

As presented above, the controller 302 determines whether the battery 212 is at a detecting moment. If so, the controller 302 accesses battery parameters from the measurement unit 222 and/or the memory 226 associated with the current detecting moment, and generates a group of balance charging parameters 462 based on those battery parameters. In the FIG. 10 embodiment, a detecting moment occurs each time the BMS 214 turns on and before every discharging round. The battery parameters used for generating the group of balance charging parameters 462 include discharging current, module voltages, previous BMS turning off time and BMS turning on time. The discharging current and module voltages are received from the measurement unit 222, and the last BMS turning off time and BMS turning on time are accessed from the memory 226. The group of balance charging parameters 462 includes the average module voltage, the idle time that can be calculated based on the previous BMS turning off time and the current BMS turning on time, and the discharging current. The comparison unit 460 compares the group of balance charging parameters 462 with a set of thresholds that includes an idle voltage threshold, a discharging voltage threshold, a time threshold, a current threshold, and a detection interval threshold. The comparison unit 460 sets a balance charging flag 6 if the average module voltage is less than the idle voltage threshold when the battery 212 is in the idle state, or the comparison unit 460 sets the balance charging flag 6 if the average module voltage is less than the discharging voltage threshold when the battery 212 is in the discharging state.

Referring to FIG. 10, in block 1010, the comparison unit 430 receives or accesses the group of balance charging parameters 462, which includes the average module voltage, the idle time and the discharging current.

In block 1020, the controller 302 determines whether the battery 212 is in the idle state or in the discharging state.

If the battery 212 is in the idle state, then the comparison unit 460 compares the idle time with the time threshold, in block 1025. If the idle time is less than the time threshold, then the flag setting process 1000 is ended, in block 1090.

If the idle time is greater than the time threshold, then the comparison unit 460 compares the average module voltage with the idle voltage threshold, in block 1035.

If the average module voltage is greater than the idle voltage threshold, then the flag setting process 1000 is ended, in block 1090.

If the average module voltage is less than the idle voltage threshold, then the comparison unit 460 sets the balance charging flag 6, in block 1080.

Referring back to block 1020, if the battery 212 is not in the idle state, then the controller 302 determines whether the battery 212 is in a discharging state, and the comparison unit 460 compares the discharging current with the current threshold, in block 1030.

If the discharging current is greater than the current threshold, then the flag setting process 1000 is ended, in block 1090.

If the discharging current is less than the current threshold, then the comparison unit 460 compares the average module voltage with the discharging voltage threshold, in block 1040.

If the average module voltage is greater than the discharging voltage threshold, then the controller 302 resets the detection interval (described below), in block 1060, and then the flag setting process 1000 is ended, in block 1090.

If average module voltage is less than the discharging voltage threshold, then the controller 302 increases the detection interval, in block 1050. In one embodiment, when the battery 212 is in the discharging state, the controller 302 requires that the average module voltage be less than the discharging voltage threshold for a certain period of time, to avoid incorrectly indicating the presence of a balance charging condition. For example, an average module voltage can be instantaneously less than the discharging threshold. However, if the controller 302 determines that there is a balance charging condition present because of an instantaneous fluctuation in average module voltage, an unnecessary balance charge will be performed. Thus, in block 1070, the comparison unit 460 compares the detection interval with the detection interval threshold. If the detection interval is greater than the detection interval threshold and the average module voltage is still less than the discharging voltage threshold, then the comparison unit 460 sets the balance charging flag 6, in block 1080.

In block 1090, the flag setting process 1000 of the comparison unit 460 is ended, and can be repeated the next time a detecting moment occurs.

Advantageously, since the comparison unit 460 sets the balance charging flag 6 based on the average module voltage in the idle state and the discharging state of battery 212, an over-discharged condition that requires a balance charging can be detected regardless of the battery status. Even if the battery 212 is in the idle state, the over-discharged condition can still be detected by the balance charging detector 224. Therefore, the balance charging can be timely performed.

In one embodiment, any one of the balance charging flags 1-6 can trigger the balance charging process. When a connection between the balance charger 204 and the battery 212 is detected, the monitoring unit 306 checks whether a balance charging flag has been set. Several rounds of balance charging, e.g., three (3) rounds, can be processed by the balance charger 204 responding to the set of balance charging flags. In one embodiment, the number of rounds of balance charging can depend on which of the balance charging flags is set. For example, the balance charging flag 1 can trigger 3 rounds of balance charging, and the balance charging flag 2 can trigger two (2) rounds of balance charging, etc. As presented above, the balance charging detector 224 sets the balance charging flag 1 based on the number of charging rounds. Thus, the balance charging flag 1, if set, indicates that the battery 212 is experiencing too many charging rounds (exceeds the round threshold), and indicates a more severe imbalance condition compared to other imbalance conditions indicated by other balance charging flags. Thus, relatively more balance charging rounds can be triggered by the balance charging flag 1.

In one embodiment, the balance charging detector 224 monitors the temperature of the battery 212, and terminates the balance charging if the battery temperature is greater than a temperature threshold.

In one embodiment, if the previous balance charging was performed too recently, e.g., the time interval between balance charging rounds is less than a threshold, then the current balance charging will not be performed even if a balance charging flag is detected.

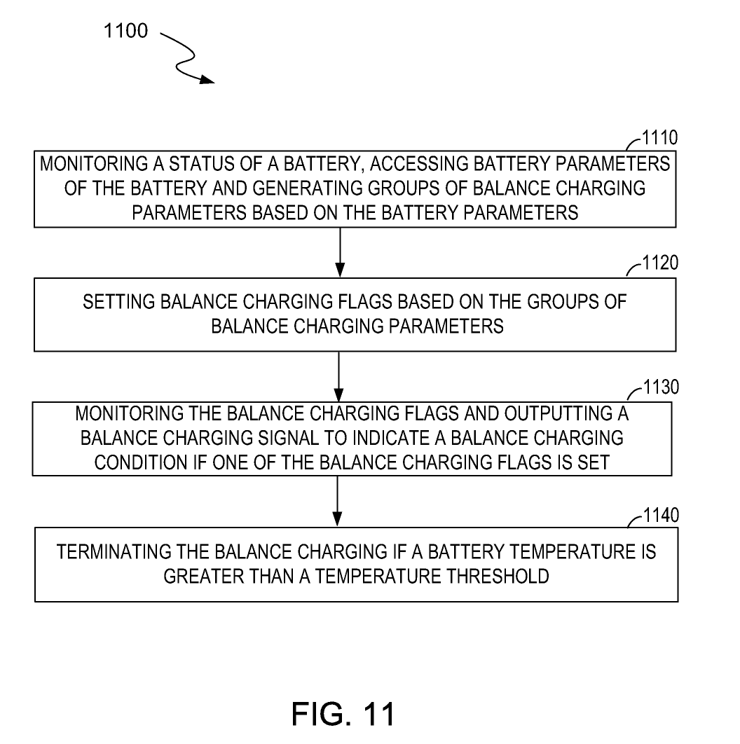

Referring to FIG. 11, a method 1100 for detecting a balance charging condition is illustrated, in accordance with one embodiment of the present invention. Although specific steps are disclosed in FIG. 11, such steps are just examples. That is, the present invention is well suited to performing various other steps or variations of the steps recited in FIG. 11. FIG. 11 is described in combination with FIG. 2 through FIG. 10.

In block 1110, one or more groups of balance charging parameters can be calculated by the controller 302 based on a plurality of battery parameters that correspond to a status of the battery 212. The battery parameters can include but are not limited to: a charging duration and a battery temperature for the preceding charging round; a cumulative count of the number of charging rounds; module voltages; an initial battery current; a discharging current; an initial discharging SOC; a battery SOC; battery pack voltages measured in the current and preceding round or rounds; cell voltages and module voltages from current and preceding round or rounds; a previous BMS turning off time and turning on time; and a calibrated SOC. All the battery parameters can be accessed/received from the measurement unit 222 and/or the memory 226. The controller 302 generates several groups, e.g., 6, of balance charging parameters based on the battery parameters. The groups of balance charging parameters can include are but not limited to: a first group of balance charging parameters including a charging duration and a battery temperature of the preceding charging round, and a cumulative count of the number of charging rounds; a second group of balance charging parameters including a module voltage difference, a discharging current difference and an average module voltage; a third group of balance charging parameters including an initial discharging SOC, a battery SOC, and a number of consecutive rounds of decreasing pack voltages; a fourth group of balance charging parameters including an average cell voltage, a module voltage difference and a number of consecutive rounds in which the module voltage difference increases; a fifth group of balance charging parameters including an idle time interval and a calibrated SOC; and a sixth group of balance charging parameters including an average module voltage, an idle time and a discharging current.

In block 1120, one or more balance charging flags are set based on a comparison of the groups of balance charging parameters and several sets of thresholds by the comparing module 304. In one embodiment, the number of sets of thresholds is the same as the number of groups of balance charging parameters. In one embodiment, the comparison unit 410 of the comparing module 304 compares the first group of balance charging parameters with a first set of thresholds including a time threshold, a temperature range and a count threshold. The comparison unit 420 compares the second group of balance charging parameters with a second set of thresholds including a voltage threshold, a current threshold, a module voltage threshold and a charging interval threshold. The comparison unit 430 compares the third group of balance charging parameters with a third set of thresholds including an initial SOC threshold, a design SOC threshold and a count threshold. The comparison unit 440 compares the fourth group of balance charging parameters with a fourth set of thresholds including a low threshold, a high threshold and a count threshold. The comparison unit 450 compares the fifth group of balance charging parameters with a fifth set of thresholds including a time threshold and a SOC threshold. The comparison unit 460 compares the sixth set of balance charging parameters with a sixth group of thresholds including an idle voltage threshold, a discharging voltage threshold, a time threshold, a current threshold and a detection interval threshold. The comparing module 304 compares each group of the balance charging parameters with the respective group of thresholds, and sets the balance charging flag(s) based on the comparison.

In block 1130, the balance charging flags are monitored, and a balance charging signal is output by the monitoring unit 306 to indicate the presence of a balance charging condition if at least one of the balance charging flags is set. When a connection between the balance charger 204 and the battery 212 is detected, the monitoring unit 306 checks whether there any of the balance charging flags have been set. Any one of the balance charging flags can trigger the balance charging signal. In one embodiment, the number of rounds of balance charging can depend on which of the balance charging flags is set.

In block 1140, the balance charging process is terminated by the balance charging detector 224 if a battery temperature is greater than a temperature threshold. In one embodiment, the controller 302 monitors the battery temperature during the balance charging.

While the foregoing description and drawings represent embodiments of the present invention, it will be understood that various additions, modifications and substitutions may be made therein without departing from the spirit and scope of the principles of the present invention as defined in the accompanying claims. One skilled in the art will appreciate that the invention may be used with many modifications of form, structure, arrangement, proportions, materials, elements, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims and their legal equivalents, and not limited to the foregoing description.

What is claimed is:

1. A balance charging detector comprising:
a controller operable for monitoring a status of a battery, for accessing a plurality of battery parameters for said battery that correspond to said status, and for generating a group of balance charging parameters based on said battery parameters; and
a comparing module coupled to said controller, and operable for setting a balance charging flag based on a comparison of said group of balance charging parameters and a set of thresholds,
wherein a balance charging signal is generated if said balance charging flag is set to indicate presence of a condition to perform a balance charging of said battery.

2. The balance charging detector of claim 1, further comprising:
a monitoring unit coupled to said comparing module and operable for monitoring said balance charging flag and for outputting said balance charging signal if said balance charging flag is set when a charger is connected to said battery.

3. The balance charging detector of claim 1, wherein said controller is operable for generating a plurality of groups of balance charging parameters based on said battery parameters, and wherein said comparing module is operable for setting a plurality of balance charging flags based on a comparison of said groups of parameters and a plurality of groups of thresholds.

4. The balance charging detector of claim 3, wherein said comparing module comprises:
a plurality of comparison units, each of which is operable for setting a corresponding balance charging flag based on a comparison of a respective group of balance charging parameters of said groups of balance charging parameters and a respective set of thresholds,
wherein said balance charging signal is generated if one of said balance charging flags is set when a charger is connected to said battery.

5. The balance charging detector of claim 1, wherein said group of balance charging parameters comprises a cumulative charging round count and said threshold comprises a count threshold, and wherein said comparing module sets said balance charging flag if said cumulative charging round count is greater than said count threshold.

6. The balance charging detector of claim 5, wherein said group of balance charging parameters further comprises a charging duration and a battery temperature, and wherein said cumulative charging round count is calculated based on said charging duration and said battery temperature.

7. The balance charging detector of claim 1, wherein said group of battery status parameters comprises a conditional module voltage difference, wherein said conditional module voltage difference corresponds to a voltage difference between two voltages cross two of said battery modules respectively, and wherein said comparing module sets said balance charging flag if said conditional module voltage difference is greater than a module voltage threshold.

8. The balance charging detector of claim 7, wherein said group of battery status parameters further comprises a discharging current difference and an average module voltage, wherein said voltage difference qualifies as said conditional module voltage difference based on said discharging current difference and said average module voltage.

9. The balance charging detector of claim 1, wherein said group of battery status parameters comprises a number of consecutive rounds of decreasing battery pack voltages, which is calculated based on a plurality of battery pack voltages corresponding to a plurality of discharging rounds respectively, and wherein said comparing module sets said balance charging flag if said number is greater than a count threshold.

10. The balance charging detector of claim 8, wherein said group of battery status parameters further comprises a battery state of charge (SOC), wherein said battery pack voltages are detected in said discharging rounds based on said battery SOC.

11. The balance charging detector of claim 1, wherein said group of battery status parameters comprises a number of consecutive rounds in which a module voltage difference increases, wherein said battery comprises a plurality of modules having a plurality of module voltages and each of said modules has a respective module voltage in a discharging round, and wherein said number is generated based on a plurality of module voltage differences, and wherein said comparing module sets said balance charging flag if said number is greater than a count threshold.

12. The balance charging detector of claim 11, wherein said number is generated based on a voltage range, wherein said number is generated based on said module voltage differences when a battery voltage of said battery is between said voltage range.

13. The balance charging detector of claim 1, wherein said group of battery status parameters comprises a conditional idle time interval, and wherein said comparing module sets said balance charging flag if said conditional idle time interval is greater than a time threshold.

14. The balance charging detector of claim 1, wherein said group of battery status parameters comprises a calibrated SOC of said battery, and wherein an idle time of said battery qualifies said conditional idle time interval based on said calibrated SOC.

15. The balance charging detector of claim 1, wherein said group of battery status parameters comprises an average module voltage, and wherein said comparing module sets said balance charging flag if said average module voltage is less than a voltage threshold.

16. The balance charging detector of claim 15, wherein said voltage threshold comprises a first threshold and a second threshold, and wherein said comparing module sets said balance charging flag if said average module voltage is less than said first threshold when said battery is in a first state, and sets said balance charging flag if said average module voltage is less than a second threshold when said battery is in a second state.

17. The balance charging detector of claim 1, wherein said controller is operable for terminating said balance charging based on a battery temperature.

18. A battery management system (BMS), comprising:
a measurement unit operable for detecting a status of a battery, wherein said status is represented by a plurality of battery parameters;
a memory coupled to said measurement unit and operable for storing a plurality of values of said battery parameters; and
a balance charging detector coupled to said measurement unit and said memory, and operable for accessing said battery parameters, detecting a condition to perform a balance charging for said battery according to said battery parameters, and generating a balance charging signal to indicate presence of a condition to perform a balance charging of said battery.

19. The BMS of claim 18, wherein said balance charging detector comprises:
a controller operable for monitoring said status of said battery, accessing said battery parameters, and generating a group of balance charging parameters based on said battery parameters; and
a comparing module coupled to said controller, and operable for setting a balance charging flag based on a comparison of said group of balance charging parameters and a set of thresholds, wherein said balance charging signal is generated if said balance charging flag is set.

20. A method for detecting a balance charging condition for a battery, said method comprising:
accessing, through a controller, a plurality of battery parameters for said battery that correspond to a status of said battery, and generating a group of balance charging parameters based on said battery parameters;
setting, through a comparing module, a plurality of balance charging flags based on a comparison of said groups of balance charging parameters and a plurality of sets of thresholds, wherein the number of said sets of thresholds is the same as the number of said groups of balance charging parameters; and
monitoring said balance charging flags and outputting a balance charging signal to indicate presence of said balance charging condition if a balance charging flag of said balance charging flags is set.

21. The method of claim 20, further comprising:
performing a number of rounds of balance charging, wherein said number corresponds to a respective balance charging flag of said balance charging flags.

22. The method of claim 20, further comprising:
monitoring a battery temperature during said balance charging; and
terminating said balance charging if said battery temperature is greater than a temperature threshold.
